(19) United States
(12) Patent Application Publication
(10) Pub. No.: US 2012/0295143 A1
(43) Pub. Date: Nov. 22, 2012

(54) ELECTROCHEMICAL ENERGY STORE AND ASSEMBLY OF A PLURALITY OF SUCH ELECTROCHEMICAL ENERGY STORES

(75) Inventor: Tim Schaefer, Harztor (DE)

(73) Assignee: Li-Tec Battery GmbH, Kamenz (DE)

(21) Appl. No.: 13/514,483

(22) PCT Filed: Dec. 8, 2010
(86) PCT No.: PCT/EP2010/007471

§ 371 Date: Jul. 30, 2012

(30) Foreign Application Priority Data
Dec. 8, 2009 (DE) 10 2009 057 368.2

(51) Int. Cl. H01M 2/20; H01M 10/50

(52) U.S. Cl. 429/72; 429/123; 429/120

(57) ABSTRACT

The invention relates to an electrochemical energy store (101, 201, 601, 701, 801) comprising a housing and electrical connections (102, 103, 202, 203, 204, 602, 603, 604, 702, 703, 704, 802, 803, 804) having a housing in the shape of a space-filling polyhedron, has a housing surface on, at or in which said electrical connections are arranged such that, when joining a plurality of said electrochemical energy stores next to and/or on top of each other, an electrical interconnection of said energy stores to form an electric series and/or parallel connection of such energy stores is created or can be brought about by establishing an electrically conductive connection of two opposing connections of neighboring energy stores each.

The invention relates to an electrochemical energy store and an assembly of a plurality of such electrochemical energy stores.

Numerous electrochemical energy store applications, particularly applications associated with electrical or hybrid-drive vehicles, require a compact and at the same time flexible assembly of a plurality of electrochemical energy stores and their flexible electrical interconnection to form a series and/or parallel connection, whereby the respective voltage needed for an application can be supplied from the voltages of the individual electrochemical energy stores.

The spatial arrangement of the individual energy stores in an assembly is thereby frequently governed by the constructional circumstances, in particular the respective application's available installation space. Electrochemical energy stores which can be spatially arranged as flexibly as the respective application permits and at the same time be thereby interconnected as easily as possible to form a series or parallel connection which provides the voltage necessary for the respective application are therefore desirable.

The prior art includes various descriptions of assemblies of a plurality of electrochemical energy stores having different properties, advantages and limitations.

Even DE 569865 from 1932 discloses a battery container for use in areas containing explosive materials which is characterized by being divided into one or more partitions sealed off from one another in explosion-proof manner.

EP 0 362 083 A1 describes a battery cabinet in which a plurality of batteries are arranged side-by-side and atop one another in rows.

EP 0 575 060 B1 describes a modular battery cabinet unit comprising a plurality of battery trays stacked one atop another and connected together, whereby each battery tray comprises a back section and opposing side sections disposed so as to provide access through an open side opposite the back section, wherein at least two of the sections contain at least one battery compartment, a restraining means attached to the battery tray to retain a battery within the battery compartment, and attachment means associated with each of the battery trays for attaching a battery tray to another battery tray.

U.S. Pat. No. 5,140,744 discloses a storage battery comprising a plurality of cells, wherein the cells are assembled using standardized multicell modules so as to be able to provide for varying physical and spatial conditions.

The present invention is based on the task of specifying an electrochemical energy store which is particularly suitable for configuring an assembly of a plurality of such electro-chemical energy stores. This task is solved by a product according to any one of the independent product claims and by a method according to any one of the independent method claims. Advantageous further developments of the invention are protected by the subclaims.

The invention provides for an electrochemical energy store having a housing and at least two electrical connections, said housing substantially in the form of a space-filling polyhedron having at least one housing surface, to, on or in which said electrical connections are disposed such that when joining and/or fitting together a plurality of such electrochemical energy stores, an electrical interconnection of these energy stores results in an electric series and/or parallel connection of said energy stores or can be created by establishing an electrically conductive connection between respectively opposing connections of neighboring energy stores.

The following will describe the terms used in conjunction with the description of the present invention:

An electrochemical energy store refers to any type of energy store from which energy can be withdrawn, wherein an electrochemical reaction occurs within said energy store. The term in particular covers galvanic cells of all types, particularly primary cells, secondary cells and interconnections of such cells to form batteries of such cells. Such electrochemical energy stores usually have negative and positive electrodes separated by a so-called separator. Ionic transport occurs between the electrodes by means of an electrolyte. The electrodes of a respective polarity are conductively connected by electrical arrestors which lead outward through the walls of the housing and are connected to the electrical connections of the energy store.

A (three-dimensional) polyhedron (also multi-sided or polytope) is a part of the three-dimensional space which is limited exclusively by straight surfaces (planes), for example a cube or an octant of a (three-dimensional) coordinate system. Examples of polyhedrons from everyday life include (in their usual design) cabinets, pyramids, houses, crystals and dice. Balls, cones, bottles and slices of pie are not polyhedrons since they have curved lateral faces. The most significant polyhedrons in geometrical application are cuboids, prisms, pyramids and parallelograms (parallelepipeds).

A space-filling polyhedron refers to a three-dimensional polyhedron which is formed so as to be able to construct a three-dimensional body without gaps or space between neighboring polyhedrons upon a plurality of such polyhedrons being joined and/or fit together. The cuboid is thus an example of a space-filling polyhedron, in particular thus the cube or the so-called parallelepiped. A parallelepiped (synonyms: parallelogram, rhomboid, parallelotope) refers to a geometrical body limited by six pairwise congruent parallelograms lying in parallel planes. In German, the term for parallelogram (“Spar”) stems from calcite (“Kalkspat” chemically: CaCO₃), the crystals of which form a parallelepiped.

Further examples of space-filling polyhedrons are those polyhedrons which, as so-called elementary cells, are suitable for characterizing a crystal lattice. An elementary cell (sometimes also called unit cell) is a unit able to construct a crystal structure by repeated translation in three directions. It is defined by six lattice parameters (lattice constants a, b and c as well as the α, β and γ angles therebetween) and contains all existing symmetry elements. For any given crystal structure, however, there is not only one but an infinite number of possibilities of defining an elementary cell.

A body which substantially exhibits the form of a space-filling polyhedron refers to a three-dimensional body having the property of a first assembly of such bodies being able to be created by joining and/or fitting together a plurality of such bodies in which each individual body of this first assembly essentially takes the same position which the form of the body of the space-filling polyhedron would substantially exhibit or should exhibit in a second assembly as formed from a corresponding joining and/or fitting together of a plurality of such space-filling polyhedron without gaps or spaces. Such a body does not necessarily have to be convex. A body is convex when the connecting line between two points of the body lies completely within the body.

Examples of such bodies include (in their usual design) substantially cuboid bricks or substantially cuboid interlocking blocks with an assembly of a plurality of nubs on an outer surface (the “upper side”) which are so arranged such that the nubs engage in a cavity in the “upper side” of the opposing outer surface when the interlocking blocks are joined and/or fit together. Interlocking blocks or hollow bricks are (in their usual design) examples of non-convex bodies which substantially exhibit the form of a space-filling polyhedron. Among other things, such interlocking blocks exhibit only “substantially” the form of a space-filling polyhedron because of these nubs, which in the case of the substantially cuboid interlocking blocks would in fact be given by the cuboid characterizing their shape.

To be understood by a housing which substantially exhibits the form of a space-filling polyhedron is a housing having an external form essentially in the form of a body which substantially exhibits the form of a space-filling polyhedron.

Joining and/or fitting together a plurality of bodies which substantially exhibit the form of a space-filling polyhedron, in particular a plurality of such housings, refers to the configuring of a first assembly of such bodies in which each individual body of this first assembly essentially takes the same position which the form of the body of the space-filling polyhedron would substantially exhibit or should exhibit in a second assembly as formed from a corresponding joining and/or fitting together of a plurality of such space-filling polyhedron without gaps or spaces. Such a joining and/or fitting together of a plurality of bodies substantially exhibiting the form of a space-filling polyhedron hence results in arrangements of such bodies, in particular such housings, which correspond to a dense or space-filling packing of polyhedrons substantially exhibiting the form of the body.

Examples of such arrangements include walls (in their usual design) or blocks (e.g. pyramids) of bricks or interlocking-type blocks. The position of the bricks or interlocking-type blocks in such a (first, material) arrangement is contingent upon the position of the respective representative polyhedron (e.g. a parallelepiped) in a corresponding (second, virtual) arrangement of such polyhedrons, in which said polyhedrons are arranged without gaps or spaces between their surfaces, but can otherwise be arranged in any manner.

Thus, the joining and/or fitting together—in the sense as defined herein—of a plurality of bodies which substantially exhibit the form of a space-filling polyhedron creates a real (first) arrangement of said bodies, which are not necessarily free of gaps or spaces. However, the corresponding virtual (second) arrangement, created by a corresponding joining and/or fitting together of the space-filling polyhedrons substantially exhibiting the form of the body, is free of gaps or spaces.

Particularly preferred are embodiments of the invention in which the housing exhibits at least one first form element which is designed such that a joining and/or fitting together of a plurality of such electrochemical energy stores contrary to the intended purpose is not possible or will not result in a space-filling assembly. Examples of such first form elements are symmetry-breaking form elements which for example have the effect of breaking; i.e. eliminating, a given rotational symmetry of a housing without such first form elements. The developing of a gap-free or space-free structure is hereby prevented upon an inadvertent rotating of a housing opposite to its intended direction upon assembling an arrangement of a plurality of such housings. This usually does not go unnoticed and can contribute to preventing a joining and/or fitting together of a plurality of such electrochemical energy stores contrary to the intended purpose and the damages or dangers which would conceivably result therefrom.

Such first form elements preferably take the form of nubs or notches affixed to, on or in a housing surface. These form elements can, however, also be realized by the form and/or the arrangement of the connections, provided these connections themselves exhibit the form of such nubs or notches, for example, or provided the arrangement of the connections yields the necessary symmetry breaking, for example.

For example, if, in other embodiments, the form of the polyhedron essentially exhibits that of the housing and is itself not rotationally symmetrical, e.g. symmetrical upon rotation about one of its axes by 90 degrees, then these first form elements can also be realized by selecting an asymmetrical polyhedron as the basic form for the housing. In such cases, the housing thus essentially exhibits the form of an asymmetrical polyhedron, which can only be assembled with a plurality of such polyhedrons in one way, i.e. in only one spatial orientation relative to other neighboring polyhedrons, into a space-filling and thus gap/space-free structure.

Further embodiments of the invention are also preferred in which the housing exhibits at least one second form element configured such that at least one fixing means, which contributes to the mechanical stabilization of a space-filling assembly of a plurality of electrochemical energy stores, can be pushed through the housing. Such second form elements are preferably realized by means of recesses, drillings or similar modifications to the housing from the form of an ideal polyhedron. Tension rods or bolts or other similar fixing means can for example be guided through such recesses or drillings.

Further embodiments of the invention in which the housing exhibits a clamping mechanism to create an electrically conductive connection between respectively opposing connections of neighboring energy stores are also preferred. Such clamping mechanisms preferably have elastic components such as springs, for example, which press the components used to create the electrically conductive connection between the connections against each other at a certain force such that these components are protected to a certain extent against unintentional disconnection.

Said elastic components are preferably mounted in cavities of the housing provided for the purpose and provided with tensioners, for example tension levers, such that said elastic components can be slightly tensioned by the assembler actuating the tensioners upon the joining and/or fitting together of neighboring housings. Releasing the tensioners thus creates the electrically conductive clamping connection between the opposing connections of neighboring energy stores.

Further embodiments of the invention in which at least one cooling means is integrated in the housing are also preferred. To realize such embodiments, the housing or a part of its walls is preferably manufactured from a thermally conductive material which is preferably provided with ducts to allow the flow of a liquid or gaseous cooling agent to increase the heat transfer to the environment. Said ducts are preferably arranged such that upon the joining and/or fitting together of a plurality of such housings, the duct openings of neighboring housings seal against one another as tightly as possible which in turn can preferably be realized using elastic seals affixed at said openings.

In this way, a network of cooling ducts is created when joining and/or fitting together a plurality of such housings from the cooling ducts of individual housings which preferably extends across the entire assembly and enables effective cooling of all of the assembly's energy stores. In place of cooling ducts in the housings, recesses can preferably also be configured in the preferably thermally conductive housing walls such that upon joining and/or fitting together a plurality of such housings, a network of flow channels is formed for a preferably gaseous cooling agent, for example air.

Further embodiments of the invention in which at least one cooling means is affixed to at least one housing surface are also preferred. With these embodiments as well, the housing or a part of its walls is preferably manufactured from a thermally conductive material. Although here, the housing wall is preferably formed such that a good thermally conductive contact can be established with a cooling means which can be affixed to said wall externally. The resulting structure of the original housing and the cooling means affixed thereto can then be employed as the housing in terms of the above-described preceding and other embodiments and corresponding to configuring an assembly by joining and/or fitting together a plurality of such housings.

The features of the above described and further embodiments of the invention can also be advantageously combined.

The following will make reference to preferred embodiments and to the figures in describing the invention in greater detail.

Shown are:

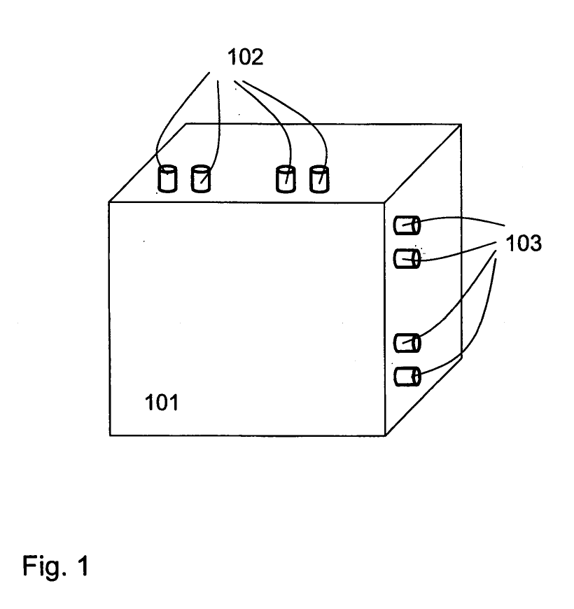

FIG. 1 a schematic depiction of a first embodiment of an inventive electrochemical energy store having electrical connections on two housing surfaces;

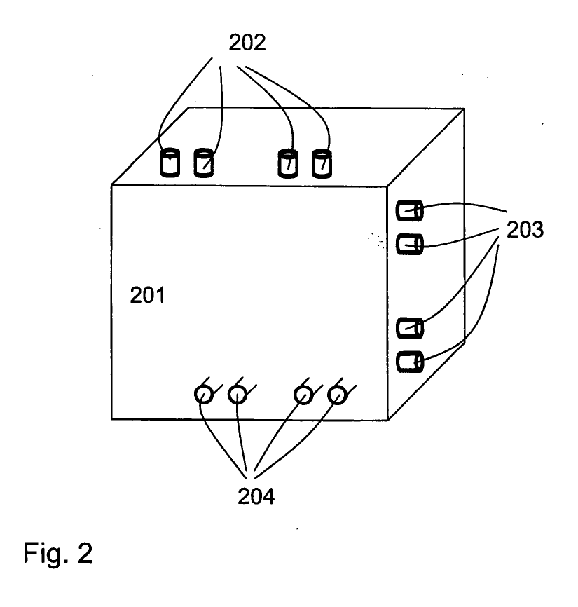

FIG. 2 a schematic depiction of a second embodiment of an inventive electrochemical energy store having electrical connections on three housing surfaces;

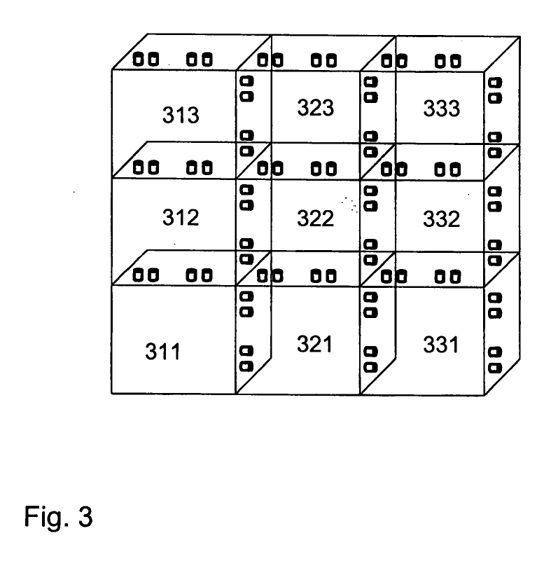

FIG. 3 a schematic depiction of an example assembly of electrochemical energy stores according to the invention;

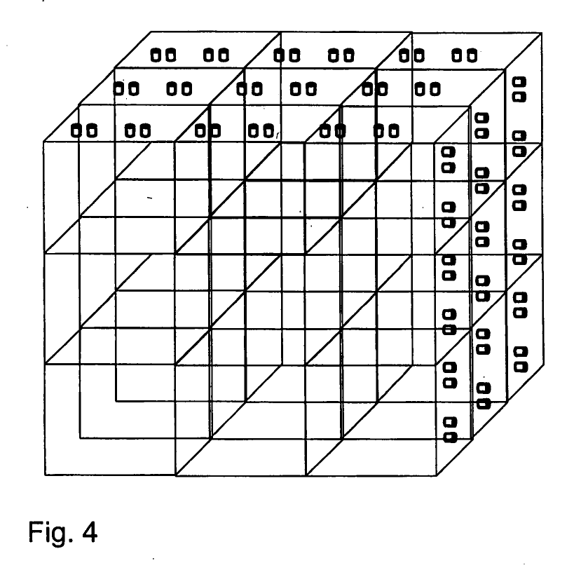

FIG. 4 a schematic depiction of a further example assembly of electrochemical energy stores according to the invention;

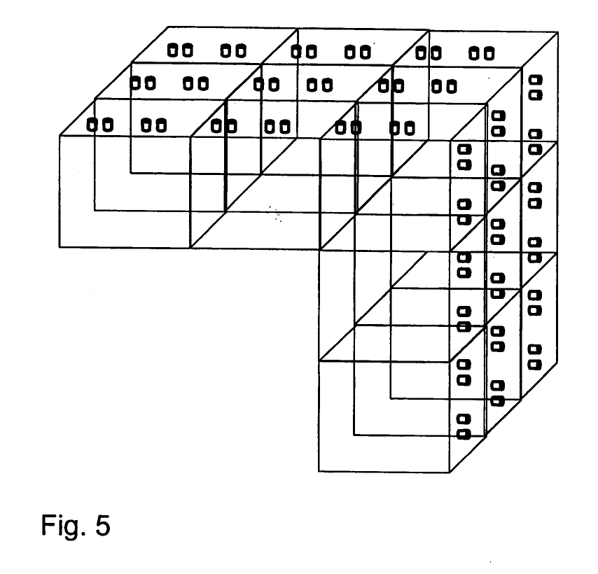

FIG. 5 a schematic depiction of a further example assembly of electrochemical energy stores according to the invention;

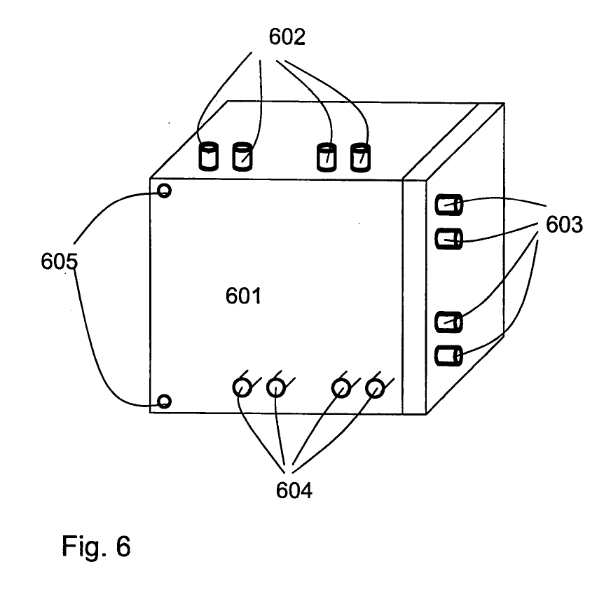

FIG. 6 a schematic depiction of a third embodiment of an inventive electrochemical energy store having electrical connections on three housing surfaces and drillings for fixing means;

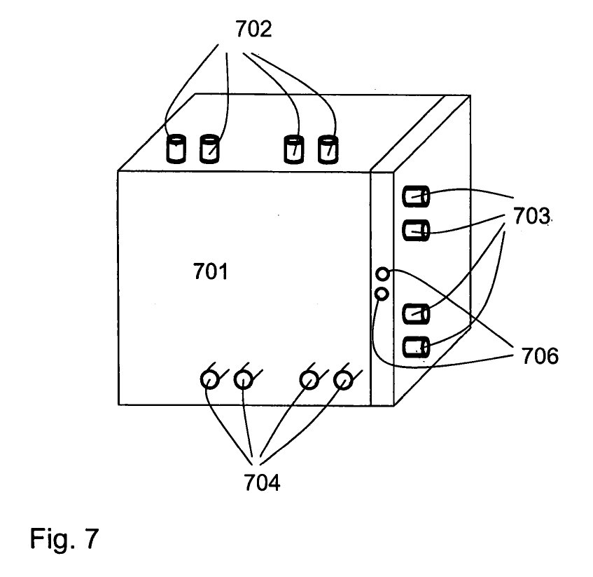

FIG. 7 a schematic depiction of a fourth embodiment of an inventive electrochemical energy store having electrical connections on three housing surfaces and cooling means;

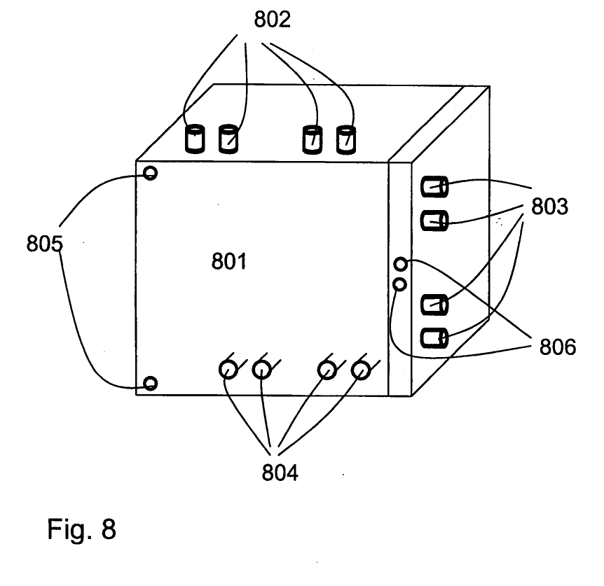

FIG. 8 a schematic depiction of a fifth embodiment of an inventive electrochemical energy store having electrical connections on three housing surfaces, drillings for fixing means and cooling means.

The electrochemical energy store comprising a housing and two groups 102, 103 of nub-shaped electrical connections mounted to two housing surfaces shown in FIG. 1 essentially has the shape of a cube or a cuboid, thus essentially the form of a space-filling polyhedron. In the example shown here, the deviations in the form of the housing from that of an ideal space-filling polyhedron, namely a cube or cuboid, are due to the nub-shaped electrical connections. However, other housing forms are also conceivable in which such deviations in the form of the housing from that of an ideal space-filling polyhedron are also due to further or other form elements such as e.g. recesses or mounting structures.

Said electrical connections are arranged on the housing surfaces such that upon a plurality of such electrochemical energy stores being joined and/or fit together, an electrical interconnection of these energy stores results in an electric series and/or parallel connection of such energy stores or same can be created by an electrically conductive connection being established between respectively opposing connections of neighboring energy stores.

To this end, appropriate connections to said connections 102, 103 are provided on the obscured housing surfaces not visible in FIG. 1 situated opposite the housing surfaces bearing the nub-shaped connections 102, 103 on the same cube or cuboid which preferably exhibit the form of cylindrical recesses in said housing surfaces and in which the preferably cylindrical nub-shaped connection elements 102, 103 of the embodiment of an electrochemical energy store shown in FIG. 1 are received once a plurality of such energy stores are joined and/or fit together in the proper orientation.

FIG. 3 shows one possible assembly of a plurality of such energy stores. Each of the connections of an energy store 311, . . . , 333 extend into the corresponding recesses of the energy store's neighboring lateral or vertical energy store (not shown in the figure) and can thereby establish electrical contact with the connection elements of the respectively neighboring energy store disposed in the recesses.

The appropriate electrical wiring of the connection elements of an energy store now enables, depending on the requirements of a technical application, realizing a necessary series and/or parallel energy store connection in the assembly. A pure series connection of energy stores thereby results in a summation of the electrical voltage generated by these energy stores while a purely parallel connection does not change the voltage but multiples the electrical capacity accordingly. Thus, by suitably combining series and/or parallel connections, virtually every required voltage can be provided at the required electrical capacity.

The inventive energy stores are therefore preferably provided in different wiring variants with which the respective contacting thereby realized between directly opposing connection elements of directly neighboring assembled and/or joined energy stores by means of a series connection and/or a parallel connection is established upon joining or fitting said energy stores together.

The electrical contact between directly opposing connections can hereby also be effected preferably automatically when joining or fitting together; i.e. by simple telescoping for example, or by means of connecting elements. Preferably feasible as such connecting elements are small conductor pieces, for example in the form of metallic clamps, tubes or of electrically conductive, silicone seals preferably containing a metallic powder which can be disposed between the directly opposing connections. Said electrically conductive silicone seals preferably containing a metallic powder have the additional advantage that they effect an elastic supporting of the energy stores.

The electrochemical energy store shown in FIG. 2 has a housing which exhibits at least one first form element (205) configured such that any joining and/or fitting together of a plurality of such electrochemical energy stores contrary to the intended purpose is not possible or results in a non-space-filling assembly. The housing of same additionally exhibits three non-coplanar housing surfaces with preferably nub-shaped connections 202, 203, 204 which correspond to the corresponding connections on the obscured housing surfaces not shown in this figure.

The assemblies of a plurality of such electrochemical energy stores as shown in FIGS. 4 and 5 can be created by joining and/or fitting together such electrochemical energy stores as shown in FIG. 2. All these assemblies are space-filling in the sense of there being no gaps or spaces between the (imagined) neighboring polyhedrons representing the housings, although gaps or spaces may well exist between the actual neighboring housings due to deviations from the ideal polyhedron form, for example because of recesses in the housing surfaces or edges. As the example of FIG. 5 shows, these assemblies are not necessarily convex because not every point on any given connecting line between two points of these assemblies necessarily has to lie within the assembly.

The first form element (205) shown in FIG. 2 is for example a nub on one of the housing surfaces as well as a corresponding recess in an opposite (not shown) obscured housing surface which is disposed such that it breaks the potentially otherwise symmetrical properties of the housing, for example an invariance of the housing under rotations about an axis of for example 90 degrees. With the corresponding symmetry-breaking arrangement and design to the connections of an energy store in accordance with the invention, however, even these ad hoc form elements can be dispensed with because the connections themselves already represent such a first form element.

The present and other embodiments of the invention can be combined with features of further embodiments of the invention, for example those shown in FIGS. 6 and 8, in which the housing exhibits at least one second form element (605, 805) configured such that at least one fixing means can be pushed though the housing, which contributes to the mechanical stabilizing of a space-filling assembly of a plurality of electrochemical energy stores. Such second form elements can be realized as drill holes through the housing, for example through peripheral parts of the housing such as e.g. through the walls of the housing. In place of drill holes, differently formed recesses or banjo bolts are also conceivable. Bars, bolts, tensioning rods or other similar fixing means can be pushed through or screwed into the housing and the housings of neighboring energy stores by way of such drill holes or recesses.

The present and other embodiments of the invention can be combined with features of further embodiments of the invention in which the housing exhibits a clamping mechanism for creating an electrically conductive connection among respectively opposing connections of neighboring energy stores. Such clamping mechanisms preferably comprise elastic components such as e.g. springs which press against the components employed for the electrically conductive connection of the connections with a certain force such that the components are protected to a certain extent from inadvertently disconnecting. Said elastic components are preferably disposed in cavities provided for the purpose and provided with tensioning means, for example clamping levers, such that said elastic components can be slightly tensioned by the assembler actuating the tensioning means when joining and/or fitting together neighboring housings. Releasing the tensioning means thereby creates the electrically conductive clamping connection between the opposing connections of neighboring energy stores.

The present and other embodiments of the invention can be combined with features of further embodiments of the invention in which at least one cooling means (706, 806) is integrated into the housing. To realize such embodiments, the housing or a part of its walls is preferably made from a thermally conductive material which is preferably equipped with ducts for the flow of a liquid or gaseous cooling agent to increase the transfer of heat to the environment. Said ducts are preferably arranged such that upon the joining and/or fitting together of a plurality of such housings, the duct openings of neighboring housings seal against one another as tightly as possible, which can in turn preferably be realized by means of elastic seals disposed at said openings.

In this way, a network of such cooling ducts is created from the cooling ducts of individual housings when a plurality of such housings are joined and/or fit together which preferably extends across the entire assembly and enables effective cooling of all the energy stores of the assembly. In place of cooling ducts in the housings, recesses can preferably also be configured in preferably thermally conductive housing walls such that a network of flow channels for a preferably gaseous cooling agent, e.g. air, is formed upon joining and/or fitting together a plurality of such housings.

The present and other embodiments of the invention can be combined with features of further embodiments of the invention in which at least one cooling means (706, 806) is affixed to at least one housing surface. In the case of these embodiments as well, the housing or a part of its walls is preferably made from a thermally conductive material. However, said housing wall is preferably formed such that it can be brought into good heat-conducting contact with a cooling means which can be affixed to said wall externally. The structure thus created from the original housing and the cooling means affixed thereto can be considered the housing in terms of the above-described and other embodiments and be employed, according to its configuration, as an assembly by the joining and/or fitting together of a plurality of such housings.

The modules (batteries, cells) of an assembly according to the invention can be stacked, for example with interspersed thermally conducting plates. The modules thereby preferably make contact by means of contact sleeves which can preferably be guided through corresponding cutouts in the thermally conducting plates.

FIGS. 3, 4 and 5 show just a few exemplary possibilities for configuring an assembly of a plurality of electrochemical energy stores according to the invention, for example according to one of the embodiments described above. Depending on the specific embodiment of the inventive electrochemical energy store employed, it is particularly possible to configure assemblies which adapt flexibly and in space-saving manner to the spatial conditions of a given application, for example the space-saving accommodation of traction batteries in the hollow spaces already provided in electric vehicles due to their design. Appropriately arranging and stacking inventive energy stores thus also allows the effective utilization of the complex space available in different application environments. Housings from so-called extruded polygon profiles preferably furnished with clamping connections can hereby be advantageously used. The invention enables a great variability in the grouping of individual storage modules or the cells within a housing, for example series and/or parallel connections in groups, thereby covering a wide range of voltages.

In the case of cell groupings in integer powers of two, thus in which the number of cells in a base module is an integer power of two, different voltages can be provided by means of different series and/or parallel connections: e.g. 28.8 V with 8 cells in series; 14.4 V with a parallel connection of 2 rows of 4 cells each; 7.2 V with a series connection of 2 groups of 4 parallel cells each; and 3.6 V with a parallel connection of 8 cells. In this way, assemblies are possible which are compatible with the most widely varying industrial or vehicle-related applications, such as for example the requirements of battery-operated lawn mowers, automotive electrics or the requirements of gardening tools.

The invention also provides for a method of producing an assembly of a plurality of inventive electrochemical energy stores, for example according to one of the preceding described embodiments, in which an electrical interconnection of said energy stores results in forming an electric series and/or parallel connection of such energy stores or same can be created by making an electrically conductive connection between respectively opposing connections of neighboring energy stores in the joining and/or fitting together of a plurality of electrochemical energy stores. To that end, said energy stores are joined together so as to create the necessary electric series and/or parallel connection of such energy stores or an electrically conductive connection is effected between respectively opposing connections of neighboring energy stores depending on the requirements of a given application. The previously cited clamping connections can also be advantageously employed hereto.

1-12. (canceled)

13. An electrochemical energy store comprising:
a housing that has a form of a space-filling polyhedron including at least one housing surface; and
at least two electrical connections disposed on the housing such that when joining or fitting together a plurality of electrochemical energy stores, an electrical interconnection of the plurality of electrochemical energy stores results in at least one of an electric series or parallel connection of said plurality of electrochemical energy stores, the electrical interconnection being establishable through electrically conductive connections between respectively opposing electrical connections of neighboring electrochemical energy stores,
wherein the housing includes a clamping mechanism comprising elastic components to press components used to establish the electrically conductive connections between opposing electrical connections of neighboring electrochemical energy stores against each other.

14. The electrochemical energy store according to claim 13, wherein said elastic components are mounted in cavities of the housing, the cavities including tensioners.

15. The electrochemical energy store according to claim 13, wherein at least part of the housing is manufactured from a thermally conductive material including ducts to allow flow of a liquid or gaseous cooling agent.

16. The electrochemical energy store according to claim 15, wherein said ducts are arranged such that duct openings of neighboring housings seal against one another upon the joining or fitting together of a plurality of housings.

17. The electrochemical energy store according to claim 16, wherein the housing comprises at least one first form element to inhibit a joining or fitting together of a plurality of electrochemical energy stores incorrectly.

18. The electrochemical energy store according to claim 17, wherein the housing comprises at least one second form element which is designed such that at least one fixing component, which contributes to mechanical stabilization of a space-filling assembly of a plurality of electrochemical energy stores, can be pushed through the housing.

19. The electrochemical energy store according to claim 13, wherein at least one cooling unit is integrated into the housing.

20. The electrochemical energy store according to claim 19, wherein at least one cooling unit is affixed to at least one housing surface.

21. An assembly of a plurality of electrochemical energy stores according to claim 13.

22. A method of producing an assembly according to claim 13, wherein an electrical interconnection of energy stores forms at least one of an electric series or parallel connection of the energy stores, the electrical interconnecting being establishable through an electrically conductive connection between respectively opposing connections of neighboring energy stores in joining or fitting together of a plurality of electrochemical energy stores, and
a clamping mechanism is used to establish an electrically conductive connection between respectively opposing connections of neighboring energy stores, the clamping mechanism including elastic components to press components used to create the electrically conductive connection between opposing connections of neighboring energy stores against each other.

23. The method according to claim 22, wherein said elastic components are mounted in cavities of the housing, the cavities including tensioners.

24. The method according to claim 23, wherein at least part of the housing is manufactured from a thermally conductive material including ducts to allow flow of a liquid or gaseous cooling agent.

25. The method according to claim 22, wherein at least one fixing component can be pushed through housings of a plurality of neighboring energy stores.

26. The method according to claim 22, wherein a cooling unit is integrated into the housing.

27. The method according to claim 22, wherein a cooling unit is affixed to the housing.

28. The electrochemical energy store according to claim 17, wherein the at least one first form element inhibits formation of a space-filling assembly when the electrochemical energy stores are joined or fitted together incorrectly.
